(19) United States
(12) Patent Application Publication
(10) Pub. No.: US 2014/0193192 A1
(43) Pub. Date: Jul. 10, 2014

(54) Connecting Structure for a Motor Vehicle and Method for Producing Same

(71) Applicant: Konrad Eipper, Rottenburg (DE)

(72) Inventor: Konrad Eipper, Rottenburg (DE)

(73) Assignee: Daimler AG, Stuttgart (DE)

(21) Appl. No.: 14/233,638

(22) PCT Filed: Jun. 23, 2012
(86) PCT No.: PCT/EP2012/002655

§ 371 Date: Mar. 12, 2014

(30) Foreign Application Priority Data
Jul. 20, 2011 (DE) 10 2011 108 156.2

(51) Int. Cl. B62D 27/02; B29C 45/14

(52) U.S. Cl. CPC B62D 27/02; B29C 45/14
USPC 403/270; 264/257

(57) ABSTRACT

A method for the production of a connecting structure for a motor vehicle involves inserting two profile elements, connected to one another by a plastic joint element, into a tool and hardening in the tool. A fiber semi-finished product with respective receivers for corresponding connecting regions of the profile elements is produced. The connecting regions of the profile elements are connected to the respective receivers of the fiber semi-finished product. The plastic joint element is produced by injecting plastic in a transfer molding process into a forming region of the tool provided for this purpose.

### BACKGROUND AND SUMMARY OF THE INVENTION

Exemplary embodiments of the invention relate to a method for producing a connecting structure for a motor vehicle and a connecting structure for a motor vehicle.

German patent document DE 10 2006 026 385 A1 disclose a connecting structure and a method for the production of such a connecting structure. Here, a plurality of hollow profile supports are connected to one another via a respective joint by first inserting the hollow profile supports into an incompressible hollow insert. Then the insert and their support openings, into which the support ends of the hollow profile support are inserted, are enclosed by soaked and curable fiber material, in particular with fiber mats. For this, the fiber material is saturated with liquid plastic and inserted into a forming tool. Then the forming tool is closed and, when subjected to temperature, the fiber material that has been soaked with liquid plastic is hardened. Thus, a respective plastic joint—consisting of the insert and the corresponding bedding material made from plastic material—is created, via which the hollow profile supports are connected to one another.

Exemplary embodiments of the present invention are directed to a method and a connecting structure in which a connecting structure is created with a simplified construction and reduced weight.

The method in accordance with the invention produces a connecting structure with a simplified construction and reduced weight by first producing at least one fiber semi-finished product, via which the at least two profile elements are to be connected to one another. For this, the respective fiber semi-finished product is provided with corresponding receivers for corresponding connecting regions of the profile elements.

After the production of the fiber semi-finished product, this is then connected to the respective profile elements in a subsequent method step, for example by inserting the corresponding connecting regions of the profile elements into the corresponding receivers of the fiber semi-finished product.

After the insertion or similar connection of the profile elements to the corresponding fiber semi-finished product, this assembly is introduced into a tool and the tool is closed. It is thus to be considered as being in the scope of the invention for the connection of the respective profile elements to the corresponding fiber semi-finished product to only be able to take place with or by insertion into the tool.

After the insertion of the components into a corresponding textured form of the tool and the closing of the tool, a plastic, in particular a resin, is injected into a forming region in the form of the tool provided for this purpose, in which the fiber semi-finished product is positioned, for the production of the respective plastic joint element. This takes place in a transfer molding process, which is typically also known as an RTM process.

Finally, in a further method step, the hardening of the respective plastic joint element takes place in the tool, and indeed preferably by a corresponding application of heat and/or pressure.

Overall, a connecting structure is thus created, which can be distinguished in particular by the type of configuration of the respective plastic joint elements. As illustrated, these are produced in a transfer molding process with the use of corresponding fiber semi-finished products. Such plastic joint elements thus have, for example, the advantage that they can be designed to be so stable and stiff that they are perfectly suited to connecting profile elements of body structures or other vehicle components, such as integral supports or cross-members, to one another. Thus, such plastic joint elements can be produced particularly simply, such that these are particularly suited to the creation of lightweight, complex structures. A further advantage of such plastic joint elements is that these can be produced with a high level of manufacturing precision, since, in particular, the respective fiber semi-finished products can themselves already be manufactured to a high level of precision. Also, the profile elements can typically be produced with extremely low tolerances, such that, overall, highly precise connecting structures can be created.

In a further advantageous embodiment of the invention, a resin or a fiber-reinforced plastic is used as the plastic for injection into the corresponding forming region of the tool. Such resins or plastics are particularly suitable for the present transfer molding process, wherein extremely stiff and stable plastic joint elements are to be created hereby.

A further advantageous embodiment provides that respective receiving openings in the fiber semi-finished product are provided as receivers. These receiving openings can already be predetermined by the formation of the respective fiber semi-finished product or textile. However, it is also conceivable for these to be produced by pre-forming the fiber semi-finished product by means of a corresponding mandrel, which penetrates the textile (between the tissue layers or even by imprinting). The opening depth of the receiving opening of the respective textile or fiber semi-finished product can thus be varied according to need by the varying depth of retraction of the mandrel.

A further advantageous embodiment of the invention provides for open profiles or hollow profiles to be used as profile elements. Such profiles or profile elements can thus be produced in a simple manner, for example by a pultrusion or extrusion method.

Finally, it has been shown to be advantageous if the respective plastic joint element is not limited to only the function in the connection of the respective profile elements, but rather also configured as a framework element, in particular a motor vehicle body or a moveable blade such as a door, hatch or hood or suchlike. Thus, it is, for example, conceivable for the body pillar of a motor vehicle body to be configured with at least one such plastic joint element, with which respective profile elements are moreover connected to one another. This enables a simple and fast production of the body with an extremely low weight and without any loss of rigidity or crash security. The production can thus take place in a single large tool, which, for example, comprises the entire side structure from the front to the rear of the vehicle. In this case, what is also conceivable is a modular construction from, for example, a pillar with one or more profile elements, which, in a subsequent assembly in a different composition, opens a way of achieving a large number of variants with individual lightweight construction-based modules.

The advantages described above in connection with the methods according to the invention also arise for the connecting structure disclosed herein.

Further advantages, features and details of the invention can be seen in the following description of preferred exemplary embodiments and by reference to the drawings.

### BRIEF DESCRIPTION OF THE DRAWING FIGURES

Here are shown:

FIG. 1 a schematic sectional view through a tool for the production of a connecting structure for a motor vehicle, wherein two profile elements are inserted into corresponding receivers of a fiber semi-finished product over respective connecting regions and this assembly is introduced into the tool, whereupon a plastic joint element is produced by injecting plastic in a transfer molding process into a forming region provided for this in a form of the tool in the region of the fiber semi-finished product, and wherein the plastic joint element comprising the injected plastic and the fiber semi-finished product is then hardened by a corresponding application of heat and/or pressure in the tool;

FIG. 2 a schematic side view of a connecting structure for a motor vehicle according to a first embodiment, wherein the connecting structure is formed as a framework structure of a moveable blade in the form of a side door;

FIG. 3 a schematic top view of a second embodiment of a connecting structure for a motor vehicle, which in the present case is formed as an auxiliary support, for example as an integral support or cross-member, to be fixed to a motor vehicle body; and

FIG. 4 a schematic side view of a third embodiment of a connecting structure, which in the present case is formed as a body structure of a personal motor vehicle with respective profile elements that are connected to one another via respective plastic joint elements.

### DETAILED DESCRIPTION

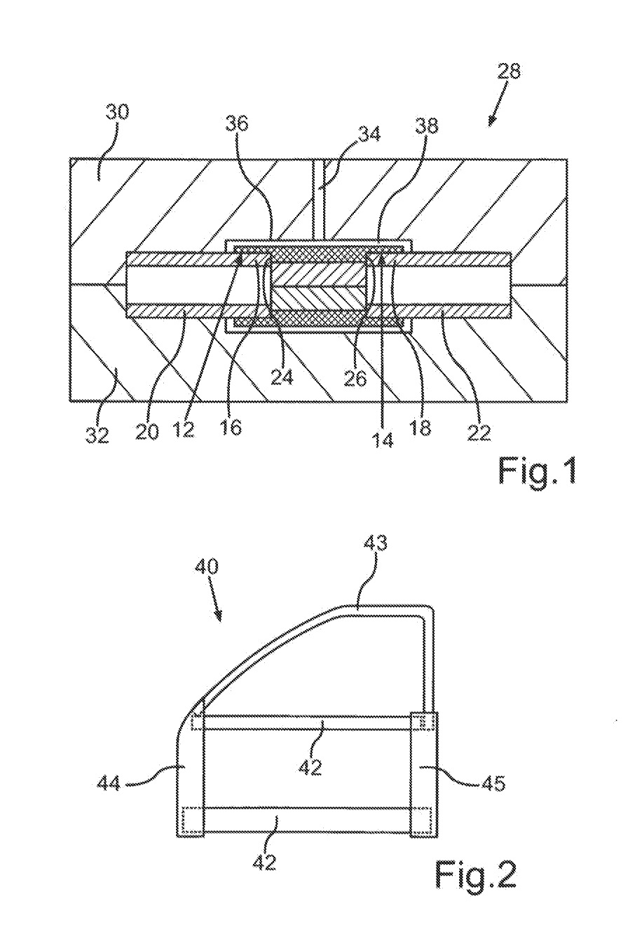

A tool for the production of a connecting structure, which will be illustrated in greater detail below, for a motor vehicle is depicted in a schematic sectional view in FIG. 1. In this context, a corresponding method for the production of this connecting structure is to be further illustrated.

The connecting structure first comprises at least one fiber semi-finished product 10, which is typically known as a so-called “preform” in conjunction with the method that is to be illustrated in greater detail below. This fiber semi-finished product 10 consists, for example, of carbon or glass fibers, which can be produced in a separate or preceding production step and can also, among other things, be pre-consolidated. During the production of this fiber semi-finished product 10, corresponding receivers 12, 14 are thus provided for corresponding connecting regions 16, 18 of respective profile elements 20, 22. In the present exemplary embodiment, the profile elements 20, 22 are configured, for example, as tubular profiles with corresponding connecting regions 16, 18, to which the receivers 12, 14 that are formed as receiving openings are fundamentally adapted in a precise manner. This precise adaptation is, however, not necessarily required. Thus, the receivers 12, 14 are presently formed as hollow, hole-like receiving openings within the fiber semi-finished product 10 that is also hollow overall, wherein, for example, respective stops 24, 26 limit the receivers 12, 14 in terms of their insertion depth, such that a highly exact, reproducible insertion depth hereby arises for the respective profile elements 20, 22. It should be noted at this point that the fiber semi-finished product 10 can naturally be configured in a plurality of potential embodiments. Instead of the receiving openings, receivers 12, 14 can also be configured, which, for example, are formed as corresponding plugs. Likewise, the fiber semi-finished product 10 is not limited to being formed as a single part. A multi-part configuration would also be conceivable. In this context, it would also be conceivable for respective subdomains of the corresponding receivers 12, 14 to be formed by respective part elements of the fiber semi-finished product 10 and for an assembly of the respective receivers 12, 14 to thus be produced during the assembly of the fiber semi-finished product 10.

After the respective profile elements 20, 22 have been inserted into the corresponding receivers 12, 14 of the fiber semi-finished product 10, these are inserted together into the tool 28 depicted in FIG. 1 and then both mold halves 30, 32 are closed. In this context, it should be noted that it is of course also conceivable in principle to connect or, if necessary, interlock the respective profile elements 20, 22 and the respective fiber semi-finished product 10 to each other only during insertion into the tool 28.

After the tool 28 has closed, the fiber semi-finished product 10 can now have a plastic, in particular a resin or a fiber-reinforced plastic, added to it in a subsequent method step in a transfer molding process, which is typically also known as an RTM (resin transfer molding) process. Formaldehyde resins or reaction resins are, in this case, particularly suitable as resins. In the present case, the injection of the plastic takes place via one or more injection channels 34, which flow(s) in a forming region 36 of a mold of the tool 28, which mold has a corresponding texture. This forming region 36 of the mold of the tool forms the negative mold of a respective plastic joint element 38, which will be illustrated in greater detail below with reference to FIGS. 2 to 4. It can thus be recognized that the respective plastic joint element 38 is formed by plastic being introduced in the region of the fiber semi-finished product 10 in the corresponding transfer molding process or by this fiber semi-finished product 10 having plastic added to it.

After the plastic, in particular the resin, has been injected into the forming region 36 provided for this purpose, in which the fiber semi-finished product 10 is present, the plastic or resin is finally hardened in a further method step by a corresponding application of heat and/or a corresponding application of pressure in the region of the forming region 36 of the tool 28.

Overall, one or more plastic joint elements 38 are thus created for connecting the respective profile elements 20, 22, which can be produced in a highly stable and simple manner. In addition, these individual plastic joint elements 38 can be produced with particular weight optimization and can be reproduced very easily.

Respective fields of application for corresponding connecting structures that have been produced according to the method illustrated in connection with FIG. 1 are to be described below with the aid of FIGS. 2 to 4.

For this purpose, FIG. 2 shows, in a schematic side view, a first embodiment of a connecting structure for a motor vehicle, which in the present case is formed as a framework structure for a side door of a personal motor vehicle. In the same way, other blade elements or moveable blades such as hoods, hatches or other doors can also be equipped with such a framework structure 40. Thus, in the present case, three profile elements 41, 42 and 43 can be detected, which form the respective support elements that run in the transverse direction of the vehicle or form an upper, fundamentally U-shaped support element that revolves around a corresponding side window, as well as two plastic joint elements 44, 45, which connect the profile elements 41, 42, 43 to one another. The plastic joint elements 44, 45 and the connecting structure designed as a framework structure 40 are thus produced in a method illustrated above in connection with FIG. 1.

In the present case, the special feature is, moreover, that the plastic joint elements 44, 45 are not limited to just the function of the connection of the respective profile elements 41, 42, 43, but are also formed as a respective framework element or a similar functional element of the moveable blade in the form of the side door. This enables a simple and fast production of the framework structure 40, which is presently formed as a door support. In addition, a very low door weight arises overall without any loss of rigidity or crash safety. The corresponding plastic joint elements 44, 45 can thus be configured in a simple manner according to need, so, for example, as a hollow profile or as an open profile, wherein functional regions such as receivers, fastening points or suchlike can be integrated.

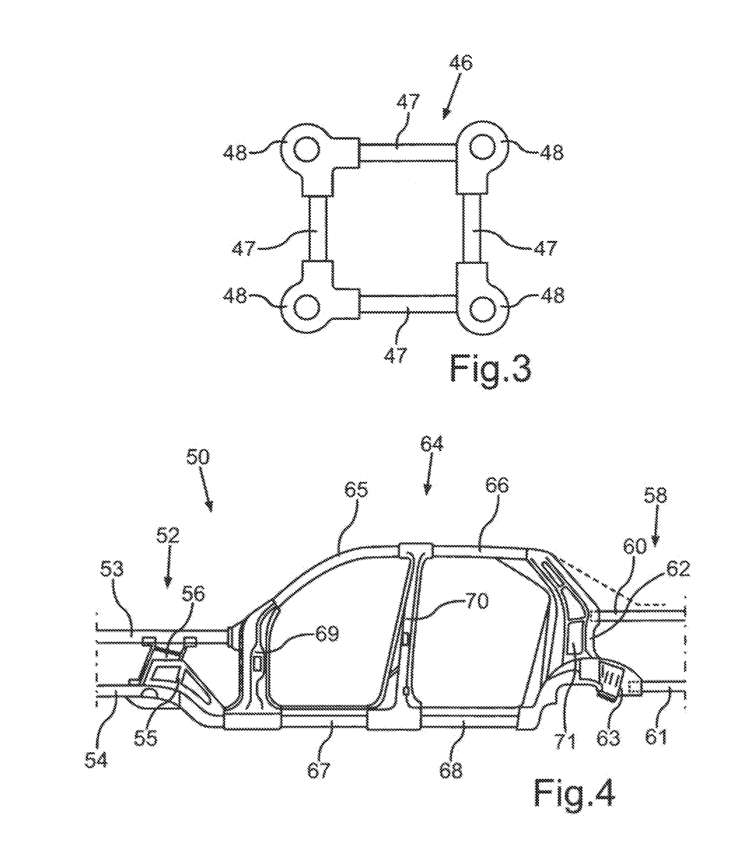

FIG. 3 shows, in a schematic top view, a further connecting structure, which has been produced according to the type of connecting structure illustrated in FIG. 1 or produced using such a method. The connecting structure according to FIG. 3 is, in the present case, formed as an auxiliary support 46 in the form of an integral support or a cross-member, which can be fastened on the underside to respective supports or similar structural elements of a front end structure or a rear structure of a body of a personal motor vehicle. Here, in the present exemplary embodiment, the auxiliary support 46 comprises four respective profile elements 47, which are connected to one another via four corresponding plastic joint elements 48 in respective corner regions of this generally frame-like auxiliary support 46.

Finally, FIG. 4 shows, in a schematic side view, a further potential embodiment of a connecting structure, which in the present case is configured at least substantially as a complete body 50 of a personal motor vehicle. Here, a plurality of profile elements 53, 54 is provided in the region of a front or a front end structure 52, which, among other things, are connected to one another by a plastic joint element 55 in the form of a connecting part comprising a suspension strut tower 56. The entire front end structure 52 and the entire front can thus be formed as a front module.

A similar configuration can be found in the region of a rear part or a rear structure 58. Here, a plurality of profile elements 60, 61 is also provided, which are formed by respective plastic joint elements 62. In the present exemplary embodiment, only the respective function of the connecting element can be transferred to these plastic joint elements 62 - incidentally just like in the front end structure 52 - or can additionally be designed advantageously or as a framework element of the respective structure. In the present case, an example of this is a longitudinal support 63 above the rear axle, which is also formed as a plastic joint element 62 that was illustrated in a corresponding transfer molding method according to the type of method described in conjunction with FIG. 1.

A plurality of profile elements is also provided in the region of a passenger compartment 64 of the body 50. Thus, for example, respective profile elements 65, 66 are provided in the region of the roof frames. The front profile element 65 in particular can thus be foamed accordingly. Here, corresponding profile elements 67, 68 can be provided in the region of respective side sills. The described profile elements 65 to 68 are thus presently connected one on top of the other via respective plastic joint elements 69, 70, 71 which in the present case are formed as an A pillar, B pillar or C pillar. Similarly to the example described in FIG. 2, framework elements or pillar elements of the body are thus also provided here, which are formed by plastic joint elements 69, 70, 71 of the corresponding connecting structure. This in turn enables a simple and fast production of the body with very low weight, without any loss in rigidity or crash safety. The production can thus take place in a single, large tool 28, which comprises the entire side structure from the front to the rear or the front end structure 52 to the rear end structure 58. A modular construction made from, for example, a corresponding pillar or a framework element with one or more profile elements is also conceivable, which, in a subsequent assembly in a different composition, opens a way of achieving a large number of variants with individual lightweight construction-based modules.

The profile elements themselves can in particular be produced as pultrusion profiles made from a fiber-reinforced plastic or from a light metal material. However, other production methods are also conceivable. The respective fiber semi-finished products 10 can—according to the field of application—have a corresponding fiber orientation, such that the respective plastic joint is adapted in a customized manner to the requirements or loads according to loss of strength.

The present connecting structure is not only suitable for corresponding framework structures 40 of blades for respective auxiliary supports 46 or for an entire body 50 or parts thereof, but also for partial compound structures or modules, for example comprising pillar and framework elements, front wall cross-members or cross-members under cowl.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for the production of a connecting structure for a motor vehicle, wherein two profile elements are inserted into a tool and connected to one another by a plastic joint element, which is hardened in the tool, the method comprising the steps of:
producing a fiber semi-finished product with respective receivers for corresponding connecting regions of the two profile elements;
connecting the connecting regions of the two profile elements to the respective receivers of the fiber semi-finished product; and
producing the plastic joint element by injecting plastic in a transfer moulding process into a forming region of the tool.

12. The method according to claim 11, wherein a resin or a fibre-reinforced plastic is used as the plastic for injecting into the forming region of the tool.

13. The method according to claim 11, wherein respective receiving openings are provided in the fibre semi-finished product as the respective receivers.

14. The method according to claim 11, wherein the two profile elements have open profiles or hollow profiles.

15. The method according to claim 11, wherein the plastic joint element is configured as a motor vehicle body or a moveable blade.

16. A connecting structure for a motor vehicle, comprising:
two profile elements connected to one another by a curable plastic joint element; and
the plastic joint element is a fiber semi-finished product that has plastic added to it in a transfer molding process.

17. The connecting structure according to claim 16, wherein respective receivers of the fibre semi-finished product are directly connected to corresponding connecting regions of the profile elements.

18. The connecting structure according to claim 16, wherein the profile elements have open profiles or hollow profiles.

19. The connecting structure according to claim 16, wherein the profile elements are formed from a light metal alloy or from a fiber-reinforced plastic.

20. The connecting structure according to claim 16, wherein the plastic joint element is formed a motor vehicle body or a moveable blade.
